(19) United States
(12) Patent Application Publication
(10) Pub. No.: US 2010/0019043 A1
(43) Pub. Date: Jan. 28, 2010

(54) Electro-optical imaging reader having plural solid-state imagers with nonconcurrent exposure

(76) Inventors: William Sackett, Rocky Point, NY (US); Edward Barkan, Miller Place, NY (US); Bradley Carlson, Huntington, NY (US); Mark Drzymala, Commack, NY (US); Michael Slutsky, Stony Brook, NY (US)

Correspondence Address: MOTOROLA, INC., 1303 EAST ALGONQUIN ROAD, IL01/3RD, SCHAUMBURG, IL, 60196, US

(21) Appl. No.: 12/220,333

(22) Filed: Jul. 23, 2008

(51) Int. Cl. G06K 7/10

(52) U.S. Cl. 235/462.42

(57) ABSTRACT

A plurality of solid-state imagers is mounted in a reader, such as a bioptical, dual window, point-of-transaction workstation, for capturing illumination light returning along different fields of view from indicia. A controller controllably activates the imagers over respective exposure time periods during which the indicia are illuminated to produce electrical signals indicative of the indicia being read, processes the electrical signals to read the indicia, and controls the exposure time periods to be nonconcurrent to prevent interference among the imagers.

### BACKGROUND OF THE INVENTION

Flat bed laser readers, also known as horizontal slot scanners, have been used to electro-optically read one-dimensional bar code symbols, particularly of the Universal Product Code (UPC) type, at a point-of-transaction workstation in supermarkets, warehouse clubs, department stores, and other kinds of retailers for many years. As exemplified by U.S. Pat. No. 5,059,779; U.S. Pat. No. 5,124,539 and U.S. Pat. No. 5,200,599, a single, horizontal window is set flush with, and built into, a horizontal countertop of the workstation. Products to be purchased bear an identifying symbol and are typically slid across the horizontal window through which a multitude of scan lines is projected in a generally upwards direction. When at least one of the scan lines sweeps over a symbol associated with a product, the symbol is processed and read.

The multitude of scan lines is generated by a scan pattern generator which includes a laser for emitting a laser beam at a mirrored component mounted on a shaft for rotation by a motor about an axis. A plurality of stationary mirrors is arranged about the axis. As the mirrored component turns, the laser beam is successively reflected onto the stationary mirrors for reflection therefrom through the horizontal window as a scan pattern of the scan lines.

It is also known to provide a point-of-transaction workstation not only with a generally horizontal window, but also with an upright or generally vertical window that faces an operator at the workstation. The generally vertical window is oriented generally perpendicularly to the horizontal window, or is slightly rearwardly or forwardly inclined. The laser scan pattern generator within this dual window or bioptical workstation also projects the multitude of scan lines in a generally outward direction through the vertical window toward the operator. The generator for the vertical window can be the same as or different from the generator for the horizontal window. The operator slides the products past either window, e.g., from right to left, or from left to right, in a “swipe” mode. Alternatively, the operator merely presents the symbol on the product to an approximate central region of either window in a “presentation” mode. The choice depends on operator preference or on the layout of the workstation.

Each product must be oriented by the operator with the symbol facing away from the operator and generally towards either window of the bioptical workstation. Hence, the operator cannot see exactly where the symbol is during scanning. In typical “blind-aiming” usage, it is not uncommon for the operator to repeatedly swipe or present a single symbol several times before the symbol is successfully read, thereby slowing down transaction processing and reducing productivity.

The blind-aiming of the symbol is made more difficult because the position and orientation of the symbol are variable. The symbol may be located either low or high, or right or left, on the product, or anywhere in between, or on any of six sides of a box-shaped product. The symbol may be oriented in a “picket fence” orientation in which the elongated parallel bars of the one-dimensional UPC symbol are vertical, or in a “ladder” orientation in which the symbol bars are horizontal, or at any orientation angle in between.

In such an environment, it is important that the laser scan lines located at, and projected from, either window provide a full coverage scan zone which extends down as close as possible to the countertop, and as high as possible above the countertop, and as wide as possible across the width of the countertop. The scan patterns projected into space in front of the windows grow rapidly in order to cover areas on products that are positioned not on the windows, but several inches therefrom. The scan zone must include scan lines oriented to read symbols positioned in any possible way across the entire volume of the scan zone.

As advantageous as these laser-based, point-of-transaction workstations are in processing transactions involving products associated with one-dimensional symbols each having a row of bars and spaces spaced apart along one direction, the workstations cannot process stacked symbols, such as Code 49 which introduced the concept of vertically stacking a plurality of rows of bar and space patterns in a single symbol, as described in U.S. Pat. No. 4,794,239, or PDF417 which increased the amount of data that could be represented or stored on a given amount of surface area, as described in U.S. Pat. No. 5,304,786, or two-dimensional symbols.

Both one- and two-dimensional symbols, as well as stacked symbols, can also be read by employing solid-state imagers which have a one- or two-dimensional array of cells or photosensors that correspond to image elements or pixels in a field of view of the imager. Such an imager may include a one- or two-dimensional charge coupled device (CCD) or a complementary metal oxide semiconductor (CMOS) device, as well as associated circuits for producing electronic signals corresponding to the one- or two-dimensional array of pixel information over the field of view.

It is therefore known to use a solid-state imager for capturing a monochrome image of a symbol as, for example, disclosed in U.S. Pat. No. 5,703,349. It is also known to use a solid-state imager with multiple buried channels for capturing a full color image of a target as, for example, disclosed in U.S. Pat. No. 4,613,895. It is common to provide a two-dimensional CCD with a 640×480 resolution commonly found in VGA monitors, although other resolution sizes are possible.

It is also known to install the solid-state imager, analogous to that conventionally used in a consumer digital camera, in a bioptical, point-of-transaction workstation, as disclosed in U.S. Pat. No. 7,191,947 in which the dual use of both the solid-state imager and the laser scan pattern generator in the same workstation is disclosed. It is possible to replace all of the laser scan pattern generators with solid-state imagers in order to improve reliability and to enable the reading of two-dimensional and stacked symbols, as well as other targets.

However, it is thought that the overall imager-based reader would require about ten to twelve imagers in order to read a symbol that could be positioned anywhere on all six sides of a product. To be successful in the marketplace, an all imager-based reader must eliminate the need for so many imagers to bring the cost of all the imagers, as well as the cost of each imager, down to an acceptable level, and it must also match, or at least be comparable to, the working range, processing speed, productivity and performance of a laser-based reader. In the case of a bioptical workstation having dual windows, the all imager-based reader must use similar window sizes and must also be able to scan anywhere across the windows and over a comparable working range as that of a laser-based reader, so that operators can achieve the high scanning productivity they have come to expect without any need to learn a new scanning technique.

As advantageous as the all imager-based bioptic reader is in reading symbols, interference among the imagers can occur if any two imagers are simultaneously operative. Each imager includes an illuminator for illuminating the symbol with illumination light from illumination light sources, e.g., light emitting diodes (LEDs). A controller is operative for controlling each illuminator to illuminate the symbol, and for controlling each imager to capture the illumination light returning from the symbol over an exposure time period to produce electrical signals indicative of the symbol being read. Each illuminator is only operative during the exposure time period. The illumination light is typically folded by field mirrors to be reflected and captured through the windows. If the exposure time periods from any two imagers are concurrent, then interference among the illuminators can be caused by multiple internal reflections from the field mirrors within the reader. The image being captured may be corrupted. Also, the possibility of uneven illumination could occur if more than one set of illumination LEDs is energized at the same time. In addition, the peak current consumption of the entire reader may be too high if more than one set of illumination LEDs are energized at the same time.

### SUMMARY OF THE INVENTION

One feature of this invention relates, briefly stated, to a reader for, and a method of, electro-optically reading indicia, comprising a housing and a plurality of solid-state, controllable imagers at the housing, for capturing light from the indicia along different fields of view. Each imager preferably comprises a two-dimensional, complementary metal oxide semiconductor coupled device (CMOS) array of submegapixel size, e.g., 752 pixels wide×480 pixels high, in order to reduce the costs of the imagers, as compared to supermegapixel arrays. Each imager includes an energizable illuminator for illuminating the indicia with illumination light from one or more illumination light sources, e.g., light emitting diodes (LEDs). A controller is operative for controllably energizing each illuminator to illuminate the indicia, for controllably activating each imager to capture the illumination light returning from the indicia over an exposure time period to produce electrical signals indicative of the indicia being read, and for processing the electrical signals to read the indicia. Each illuminator is only operative during the respective exposure time period of its associated imager.

The imagers are preferably commonly mounted on a circuit board. This assembly enables joint installation at, and joint removal from, the housing for ease of serviceability. Advantageously, each illuminator is commonly mounted on the same circuit board. The controller is also preferably commonly mounted on the circuit board. Thus, by mounting most, if not all, of the electrical components on the same board, field maintenance is simplified.

In a preferred embodiment, the housing has one window located in a generally horizontal plane, and another window located in a generally upright plane that intersects the generally horizontal plane, thereby comprising a bioptical workstation. Preferably, the circuit board on which the electrical components are mounted is no more than 100 millimeters below the generally horizontal plane. The imagers capture the light from the indicia through at least one of the windows. A first sub-plurality, e.g., three, of the imagers captures the light from the indicia through one of the windows, and a second sub-plurality, e.g., another three, of the imagers captures the light from the indicia through another of the windows. Each sub-plurality of the imagers captures the light from the indicia over different, intersecting fields of view.

Advantageously, the return illumination light travels along an optical path within the housing between a respective window and a respective imager for a distance of at least thirty-five centimeters. Folding optics, such as stationary field mirrors, are operative for folding the optical path within the housing. Also, non-rotationally symmetrical optics, such as mirrors and lenses, are operative for optically modifying the field of view of at least one imager to correspond with at least one of the dimensions of the window. The optical elements within the housing, for folding at least one of the optical paths, are preferably commonly mounted on a support, particularly an enclosure that keeps dust, dirt, moisture, and like contaminants from reaching these optical elements. This support enables joint installation of the optical elements at, and joint removal of the optical elements from, the housing for ease of serviceability. The non-rotationally symmetrical optics for optically modifying the field of view of at least one of the imagers are preferably mounted on the respective imager.

By way of numerical example, the generally horizontal window in a conventional laser-based bioptical workstation measures about four inches in width by about six inches in length, and the generally vertical window measures about six inches in width by about ten inches in length. The field of view of an imager capturing illumination light from the imager through a respective window does not inherently have these dimensions at the respective window and, hence, the field of view must be modified so that it matches the dimensions of the respective window at the respective window, thereby enabling indicia to be reliably read when located anywhere at the respective window, as well as within a range of working distances therefrom.

In accordance with one feature of this invention, each imager and illuminator is controlled to capture the illumination light from the indicia during different exposure time periods to avoid mutual interference among the imagers and the illuminators. In one embodiment, the imagers are inactive by default, and the controller is operative in a snapshot mode for sequentially activating the imagers with respective trigger pulse signals spaced timewise apart in a sequence, the trigger pulse signals being nonconcurrent. In another embodiment, the imagers are operative in a free-running mode by default. In this free-running mode, each imager continuously captures a new image every 16.6 milliseconds or so without the need for an external trigger pulse signal. The controller ensures that the imagers operate nonconcurrently by starting the operation of each imager at a different time via each imager's command interface. Additional trigger signals or commands are then no longer needed.

In accordance with another feature of this invention, the method of electro-optically reading indicia is performed by illuminating the indicia with illumination light when a plurality of energizable illuminators are energized, by capturing the illumination light returned from the indicia along different fields of view when a plurality of solid-state, controllable imagers are activated, by controllably energizing the illuminators to illuminate the indicia, by controllably activating the imagers to capture the illumination light returning from the indicia over respective exposure time periods during which the indicia are illuminated by the illumination light to produce electrical signals indicative of the indicia being read, by processing the electrical signals to read the indicia, and by controlling the exposure time periods to be nonconcurrent to prevent interference among the imagers.

Hence, an all imager-based reader has been proposed that matches, or at least is comparable to, the working range, processing speed, productivity and performance of the laser-based reader. In the case of a bioptical workstation having dual windows, the all imager-based reader uses similar window sizes, and the indicia is able to be scanned anywhere across the windows and over a comparable working range as that of the laser-based reader, so that operators can achieve the high scanning productivity they have come to expect without any need to learn a new scanning technique. Interference among the imagers cannot occur because the exposure time periods of no two imagers are simultaneous. Typical exposure time periods are 300 microseconds or less, and it takes about 16 milliseconds to transfer the image out of the imager. No multiple internal reflections from the field mirrors within the reader are generated. The image being captured is not corrupted. Also, uneven illumination due to energizing more than one set of illumination LEDs at the same time does not occur. In addition, the peak current consumption of the entire reader is minimized.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a dual window, bioptical, point-of-transaction workstation or reader operative for reading indicia in accordance with this invention;

FIG. 2 is a part-sectional, part-diagrammatic, schematic view of a workstation analogous to that shown in FIG. 1;

FIG. 3 is a perspective view of a dual window, bioptical, point-of-transaction workstation or reader operative for reading indicia in accordance with this invention using a trio of imagers;

FIG. 4 is a view similar to FIG. 3 of another embodiment of this invention using six imagers;

FIG. 5 is a schematic view to of one embodiment of a control circuit for controlling the imagers of the embodiment of FIG. 4 in a snapshot mode;

FIG. 6 is a timing diagram of the nonconcurrent trigger signals used in the control circuit of FIG. 5; and

FIG. 7 is a schematic view of another embodiment of a control circuit for controlling the imagers of the embodiment of FIG. 4 in a free-running mode.

### DETAILED DESCRIPTION OF THE PREFERRED EMBODIMENTS

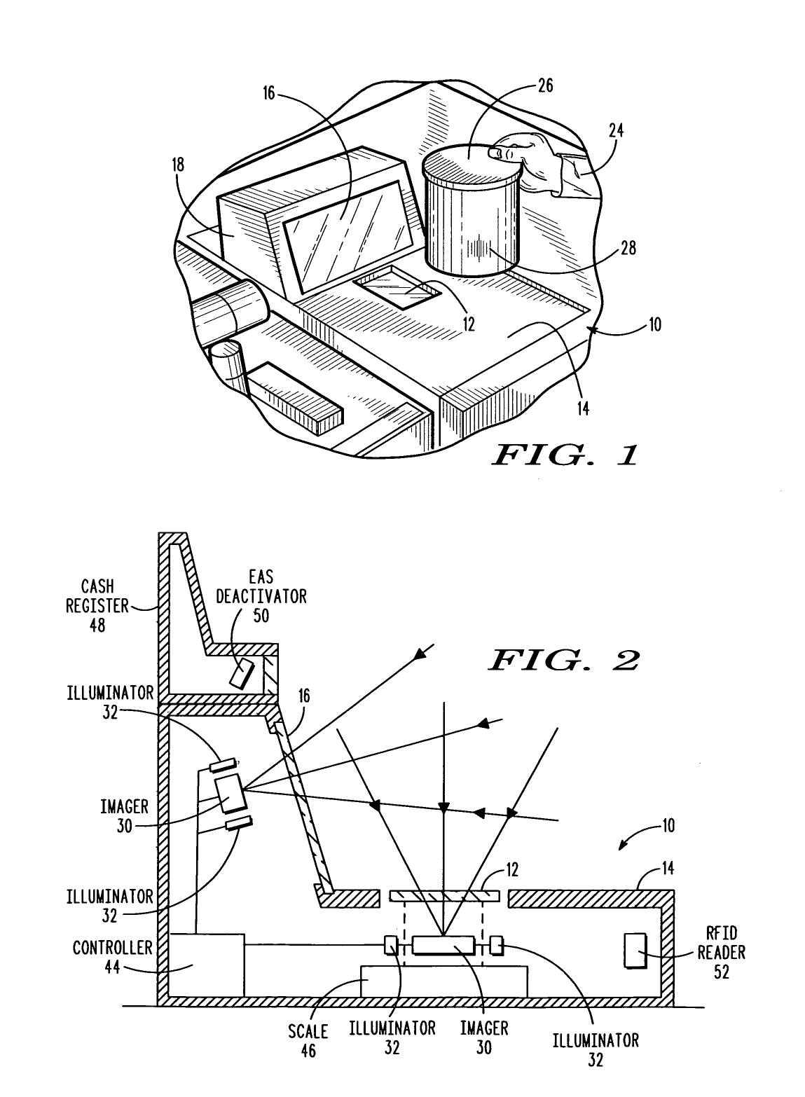

FIG. 1 depicts a dual window, bioptical, point-of-transaction workstation 10 used by retailers to process transactions involving the purchase of products bearing an identifying target, such as the UPC symbol described above. Workstation 10 has a generally horizontal window 12 set flush with, or recessed into, a countertop 14, and a vertical or generally vertical (referred to as “vertical” or “upright” hereinafter) window 16 set flush with, or recessed into, a raised housing portion 18 above the countertop.

As schematically shown in FIG. 2, a plurality of solid-state imagers 30, each including an illuminator 32, are also mounted at the workstation, for capturing light passing through either or both windows from a target which can be a one- or two-dimensional symbol, such as a two-dimensional symbol on a driver's license, or any document, as described below. Each imager 30 is a solid-state area array, preferably a CCD or CMOS array, of submegapixel size. Each imager 30 preferably has a global shutter, as described below. Each illuminator 32 is preferably one or more light sources, e.g., surface-mounted, light emitting diodes (LEDs), located at each imager 30 to uniformly illuminate the target, as further described below.

In use, an operator 24, such as a person working at a supermarket checkout counter, processes a product 26 bearing a UPC symbol 28 thereon, past the windows 12, 16 by swiping the product across a respective window in the abovementioned swipe mode, or by presenting the product at the respective window in the abovementioned presentation mode. The symbol 28 may located on any of the top, bottom, right, left, front and rear, sides of the product, and at least one, if not more, of the imagers 30 will capture the illumination light reflected, scattered, or otherwise returning from the symbol through one or both windows. The imagers are preferably looking through the windows at around 45° so that they can each see a side of the product that is generally perpendicular to, as well as generally parallel to, a respective window.

FIG. 2 also schematically depicts that a weighing scale 46, a cash register 48, and an electronic article surveillance (EAS) deactivator 50 are mounted at the workstation. The generally horizontal window 12 advantageously serves not only as a weighing platter for supporting a product to be weighed, but also allows the return light to pass therethrough. The register 48 can sit atop the raised housing portion 18, or be integrated therewith. A radio frequency identification (RFID) reader 52 is also advantageously mounted at the workstation. The reader 52 can be mounted at any location and not only below the countertop 14, as shown.

As also schematically shown in FIG. 2, the imagers 30 and their associated illuminators 32 are operatively connected to a programmed microprocessor or controller 44 operative for controlling the operation of these and other components. Preferably, the microprocessor is the same as the one used for decoding the return light scattered from the target and for processing the captured target images.

In operation, the microprocessor 44 sends successive command signals to the illuminators 32 to pulse the LEDs for a short time period of 300 microseconds or less, and successively activates the imagers 30 to collect light from a target only during said time period, also known as the exposure time period. By acquiring a target image during this brief time period, the image of the target is not excessively blurred even in the presence of relative motion between the imagers and the target.

There are several different types of targets that have particular utility for the enhancement of the operation of the workstation. The target may be a personal check, a credit card, or a debit card presented by a customer for payment of the products being purchased. The operator need only swipe or present these payment targets at one of the windows for image capture.

The target may also be a signature, a driver's license, or the consumer himself or herself. Capturing an image of the driver's license is particularly useful since many licenses are encoded with two-dimensional indicia bearing age information, which is useful in validating a customer's age and the customer's ability to purchase age-related products, such as alcoholic beverages or tobacco products.

The target may be the operator himself or herself, which is used for video surveillance for security purposes. Thus, it can be determined if the operator is actually scanning the products, or passing them around the window in an effort to bypass the window and not charge the customer in a criminal practice known in retailing as “sweethearting”.

The target may, of course, be a two-dimensional symbol whose use is becoming more widespread, especially in manufacturing environments and in package delivery. Sometimes, the target includes various lengths of truncated symbols of the type frequently found on frequent shopper cards, coupons, loyalty cards, in which case the area imagers can read these additional symbols.

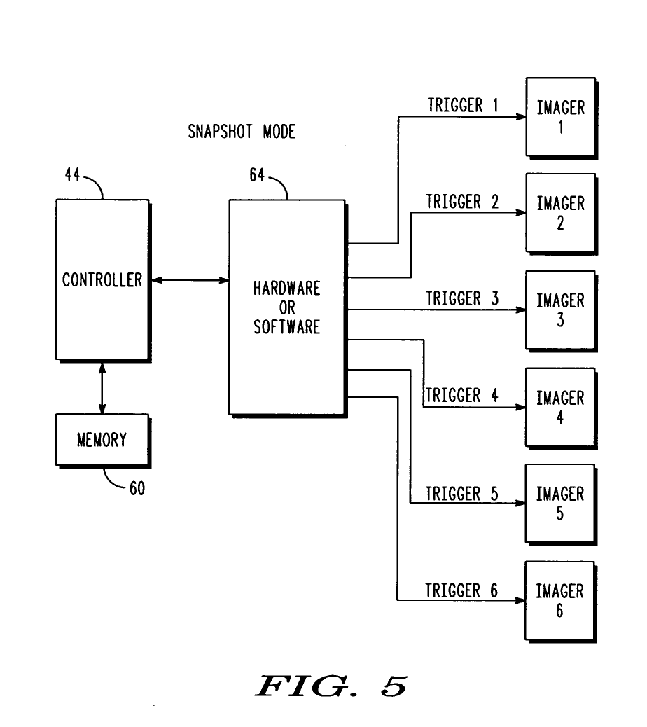

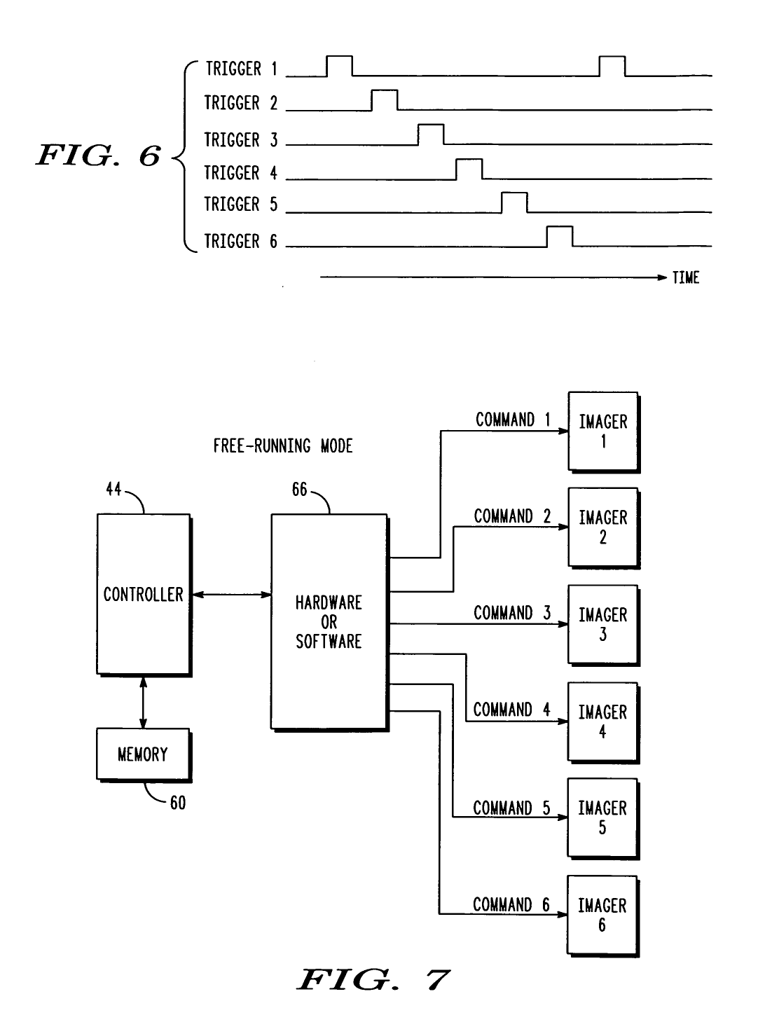

The activation of the imagers 30 can be manual and initiated by the operator. For example, the operator can depress a button, or a foot pedal, at the workstation. Preferably, the activation is automatic. For example, the imagers can operate in a continuous image acquisition or free-running mode, as described below in connection with FIG. 7. The free-running mode is the desired mode for video surveillance of the operator, as well as for decoding two-dimensional symbols. As described below in connection with FIGS. 5-6, the imagers can also operate in a snapshot mode, in which trigger signals are employed to sequentially activate the imagers. In the preferred embodiment, all the imagers will be continuously sequentially activated for scanning symbols until such time as there has been a period of inactivity that exceeds a pre-programmed time interval. For example, if no symbols have been scanned for ten minutes, then after this time period has elapsed, the reader enters a power-savings mode in which one or more of the imagers will be omitted from sequential activation. Alternatively, illumination levels may be reduced or turned off. At least one imager may remain active for periodically capturing images. If the active imager detects anything changing within its field of view, this will indicate to the operator that a product bearing a symbol is moving into the field of view, and illumination and image capture will resume to provide high performance scanning.

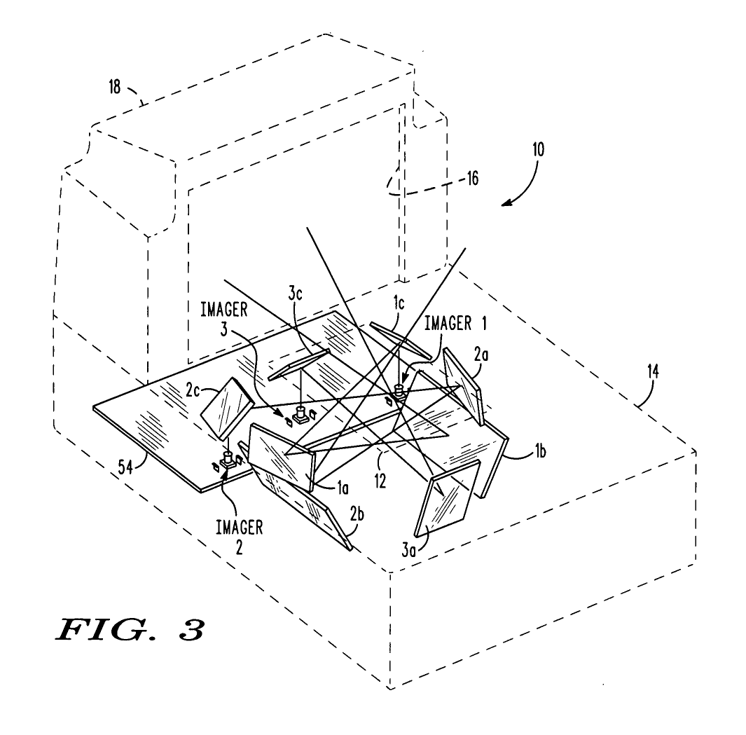

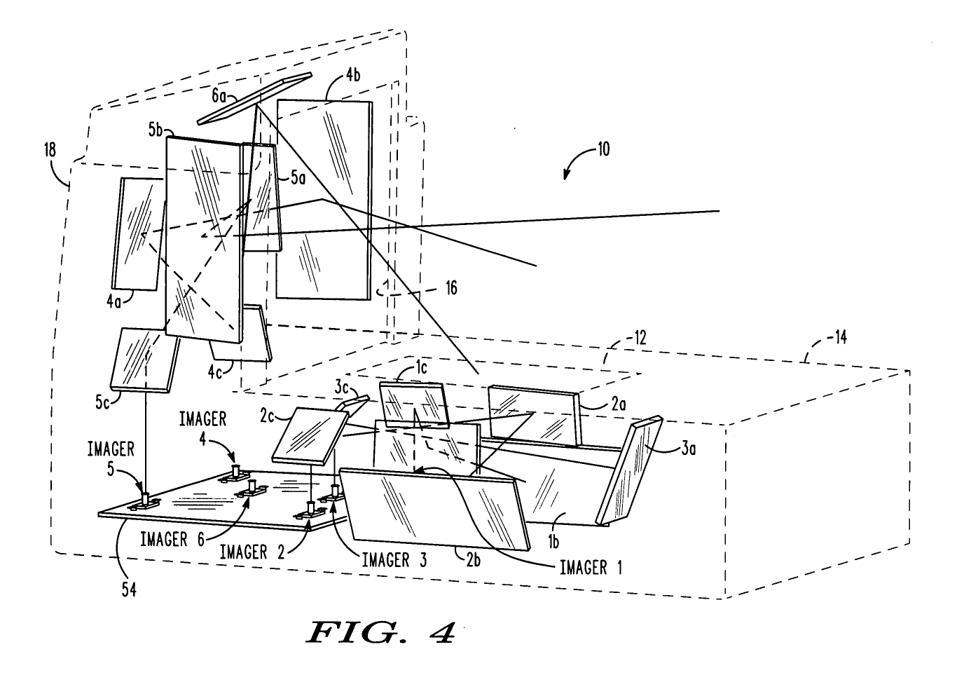

As previously stated, FIG. 2 is only a schematic representation of an all imager-based reader as embodied in a bioptical workstation. Other housings having different shapes, with one or more windows, are also within the spirit of this invention. A practical depiction of a bioptical workstation in accordance with this invention is shown in FIGS. 3-4, in which all the imagers, now relabelled 1, 2, 3, 4, 5, and 6, and, optionally, their illuminators 32, as well as other electrical components, as described below, are commonly mounted on a printed circuit board 54 for joint installation at, and joint removal from, the workstation 10 for ease of serviceability.

As shown in FIG. 3, the board 54 lies in a generally horizontal plane generally parallel to, and below, the generally horizontal window 12, and imager 1 faces generally vertically upward toward an inclined folding mirror 1c directly overhead at a right side of the window 12. The folding mirror 1c faces another inclined narrow folding mirror 1a located at a left side of the window 12. The folding mirror 1a faces still another inclined wide folding mirror 1b adjacent the mirror 1c. The folding mirror 1b faces out through the generally horizontal window 12 toward the left side of the workstation.

Imager 2 and its associated optics is mirror symmetrical to imager 1 and its associated optics. Imager 2 faces generally vertically upward toward an inclined folding mirror 2c directly overhead at the left side of the window 12. The folding mirror 2c faces another inclined narrow folding mirror 2a located at the right side of the window 12. The folding mirror 2a faces still another inclined wide folding mirror 2b adjacent the mirror 2c. The folding mirror 2b faces out through the generally horizontal window 12 toward the right side of the workstation.

Imager 3 and its associated optics are located generally centrally between imagers 1 and 2 and their associated optics. Imager 3 faces generally vertically upward toward an inclined folding mirror 3c directly overhead generally centrally of the window 12 at one end thereof. The folding mirror 3c faces another inclined folding mirror 3a located at the opposite end of the window 12. The folding mirror 3a faces out through the window 12 in an upward direction toward the raised housing portion 18.

As described so far, a trio of imagers 1, 2 and 3 capture light along different, intersecting fields of view along different directions through the generally horizontal window 12. Turning now to FIG. 4, an additional trio of imagers 4, 5 and 6 capture light along different, intersecting fields of view along different directions through the generally vertical window 16.

More particularly, imager 4 faces generally vertically upward toward an inclined folding mirror 4c directly overhead at a right side of the window 16. The folding mirror 4c faces another inclined narrow folding mirror 4a located at a left side of the window 16. The folding mirror 4a faces still another inclined wide folding mirror 4b adjacent the mirror 4c. The folding mirror 4b faces out through the generally vertical window 16 toward the left side of the workstation.

Imager 5 and its associated optics is mirror symmetrical to imager 4 and its associated optics. Imager 5 faces generally vertically upward toward an inclined folding mirror 5c directly overhead at the left side of the window 16. The folding mirror 5c faces another inclined narrow folding mirror 5a located at the right side of the window 16. The folding mirror 5a faces still another inclined wide folding mirror 5b adjacent the mirror 5c. The folding mirror 5b faces out through the generally vertical window 16 toward the right side of the workstation.

Imager 6 and its associated optics are located generally centrally between imagers 4 and 5 and their associated optics. Imager 6 faces generally vertically upward toward an inclined folding mirror 6a directly overhead generally centrally of the window 16 at an upper end thereof. The folding mirror 6a faces out through the window 16 in a downward direction toward the countertop 14.

The all imager-based reader described herein is capable of reading indicia located anywhere on all six sides of a product, and to do so within a large scan volume over a relatively long working range. The cost of the individual imagers must be minimized and, hence, relatively inexpensive imagers having submegapixel sizes are preferred. For example, a wide VGA sensor array of 752×480 pixels can be used.

Each array should have a global shutter so that the captured images will not be disturbed by motion of the indicia relative to the window(s) during the exposure time period. The indicia can be presented or swiped at speeds up to around 100 inches per second across any part of either window. For an imager to be able to read an indicium that is moving rapidly, the indicium must be brightly illuminated by the illuminator 32 so that a short exposure time can be used. Bright illumination light shining out of either window can be annoying or uncomfortable to the operator, so the illumination light sources must not be directly viewable by the operator, or by a consumer standing nearby. A rolling or a mechanical shutter could also be employed.

In the preferred embodiment, as noted above, each imager has an associated set of LEDs 32 that illuminate the indicia. The LED illumination systems include lenses (not shown) that concentrate the LED illumination light of each illuminator into a solid angle that approximately matches the field of view of each imager. The illumination for each imager is reflected off of the same folding mirrors as the field of view of its associated imager.

In many locations, the indicia can be seen by more than one imager. For example, an indicium located flat against the horizontal window 12 can be seen by both imager 1 and imager 2. These two imagers look at the indicium from different angles, and their associated illuminators 32 illuminate the indicium from different angles. As a result, a glossy indicium which may be obscured by specular reflection from the point of view of one of the imagers 1, 2 will not be obscured as seen from the position of the other imager 2, 1, so that the indicium will still be readable. Of course, the reader's capability to read any indicium is increased by its ability to see the indicium with more than one imager, even in situations where specular reflection is not an issue.

In operation, according to this invention, the imagers will not be capturing images all at the same time. For example, as shown in FIG. 5, one embodiment of a control circuit for preventing interference among the imagers includes the aforementioned controller 44, a memory 60 accessible by the controller, and a hardware or software circuit 64 together operative in a snapshot mode for sequentially activating the imagers with respective trigger pulse signals spaced timewise apart in a timing sequence, as best seen in FIG. 6. The trigger pulse signals are nonconcurrent.

Thus, in the snapshot mode, the imager 1 might capture an image first, followed by imager 2, imager 3, etc. Each imager will need an exposure time period that is less than about 0.5 milliseconds, and each imager can capture a new image every 16.6 milliseconds or so. Hence, if each imager captures an image approximately every 2.7 milliseconds, all the imagers will capture an image about every 16.6 milliseconds with the exposure time periods of no two imagers being at the same time. The illumination LEDs 32 associated with each imager will only be energized during that imager's exposure time. This eliminates the possibility of uneven illumination that could occur if more than one set of illumination LEDs was energized at the same time. It also minimizes the peak current consumption of the entire reader, by eliminating the need to energize more than one set of illumination LEDs at the same time.

As shown in FIG. 7, another embodiment of a control circuit for preventing interference among the imagers includes the aforementioned controller 44, the memory 60 accessible by the controller, and a hardware or software circuit 66 to initiate a free-running mode by sequentially commanding the imagers to begin free-running operation. In the free-running mode, the imagers automatically capture a new image every 16.6 milliseconds or so and repeat this continuously without the need for an external trigger. Thus, as long as each imager begins the free-running mode at a different time, then the capture of the images will be nonconcurrent.

The preferred embodiment shown is for a six-sided reader. Six-sided reading is most commonly used in supermarkets. Department stores and mass merchandisers, however, often use bioptical readers, but do not need a six-sided scanning capability. A less expensive imaging bioptical reader can be created for department stores and mass merchandisers by eliminating one of more imagers. For example, elimination of imagers 3 and 6 will still provide performance adequate for the needs of many department stores.

It will be understood that each of the elements described above, or two or more together, also may find a useful application in other types of constructions differing from the types described above.

While the invention has been illustrated and described as embodied in a point-of transaction workstation for electro-optically reading indicia by using plural imagers, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

1. A reader for electro-optically reading indicia, comprising:
a housing;
a plurality of energizable illuminators at the housing, for illuminating the indicia with illumination light when energized;
a plurality of solid-state, controllable imagers at the housing, each of the imagers positioned to capture the illumination light returned from the indicia along a different flekls field of view when controlled; and
a controller for controllably energizing the illuminators to illuminate the indicia, for controllably activating the imagers to capture the illumination light returning from the indicia over respective exposure time periods during which the indicia are illuminated by the illumination light to produce electrical signals indicative of the indicia being read, for processing the electrical signals to decode the indicia, and for controlling the exposure time periods of the imagers to be nonconcurrent to prevent interference among the imagers.

2. The reader of claim 1, wherein the housing has one window located in a generally horizontal plane, and another window located in a generally upright plane that intersects the generally horizontal plane, and wherein the imagers capture the light from the indicia through at least one of the windows.

3. The reader of claim 2, wherein a first sub-plurality of the imagers captures the light from the indicia through one of the windows, and wherein a second sub-plurality of the imagers captures the light from the indicia through another of the windows, and wherein each sub-plurality of the imagers captures the light from the indicia over different, intersecting fields of view.

4. The reader of claim 1, wherein each imager includes one of a two-dimensional, charge coupled device (CCD) array and a complementary metal oxide semiconductor (CMOS) array, each of submegapixel size.

5. The reader of claim 1, wherein the imagers are inactive by default, wherein the controller is operative in a snapshot mode for sequentially activating the imagers with respective trigger pulse signals spaced timewise apart in a sequence, and wherein the trigger pulse signals are nonconcurrent.

6. The reader of claim 1, wherein the imagers are sequentially commanded by the controller to operate in a free-running mode to continuously capture images at nonconcurrent times.

7. The reader of claim 1, wherein the controller is operative for deactivating at least some of the imagers if none of the imagers has captured any illumination light from the indicia after a predetermined time interval has elapsed.

8. The reader of claim 1, wherein the illumination light from the illuminators travels along respective folded optical paths within the housing to the indicia, and wherein the illumination light returning from the indicia travels along respective folded optical paths within the housing to the respective imagers.

9. A reader for electro-optically reading indicia, comprising:
means for illuminating the indicia with illumination light;
a plurality of solid-state, controllable imagers, for capturing the illumination light returned from the indicia along different fields of view;
means for controllably illuminating the indicia;
means for controllably activating the imagers to capture the illumination light returning from the indicia over respective exposure time periods during which the indicia are illuminated by the illumination light to produce electrical signals indicative of the indicia being read, the exposure time periods of the imagers being nonconcurrent to prevent interference among the imagers; and
means for processing the electrical signals to fead decode the indicia.

10. A method of electro-optically reading indicia, comprising the steps of:
controllably energizing a plurality of energizable illuminators to illuminate the indicia;
controllably activating a plurality of solid-state, controllable imagers to capture the illumination light returning from the indicia along different fields of view over respective exposure time periods during which the indicia are illuminated by the illumination light, the exposure time periods being nonconcurrent to prevent interference among the imagers;
generating to electrical signals indicative of the indicia being read; and
processing the electrical signals to decode the indicia.

11. The method of claim 10, further comprising configuring a housing with one window located in a generally horizontal plane, and another window located in a generally upright plane that intersects the generally horizontal plane, and wherein capturing the illumination light returning from the indicia is performed by capturing the illumination light from the indicia through at least one of the windows.

12. The method of claim 11, wherein capturing the illumination light is performed by capturing the illumination light by a first sub-plurality of the imagers through one of the windows, and wherein the capturing the illumination light is performed by capturing the illumination light by a second sub-plurality of the imagers through another of the windows, and wherein each sub-plurality of the imagers captures the illumination light from the indicia over different, intersecting fields of view.

13. The method of claim 10, wherein each imager comprises one of a two-dimensional, charge coupled device (CCD) array and a complementary metal oxide semiconductor (CMOS) array, each of submegapixel size.

14. The method of claim 10, further comprising deactivating the imagers by default, and wherein the controllably activating step is performed in a snapshot mode by sequentially activating the imagers with respective trigger pulse signals spaced timewise apart in a sequence, and by configuring the trigger pulse signals to be nonconcurrent.

15. The method of claim 10, further comprising sequentially commanding the imagers to operate in a free-running mode to continuously capture images at nonconcurrent times.

16. The method of claim 10, further comprising deactivating at least some of the imagers if none of the imagers has captured any illumination light from the indicia after a predetermined time interval has elapsed.

17. The method of claim 10, further comprising folding the illumination light from the illuminators to travel along respective folded optical paths within a housing to the indicia, and folding the illumination light returning from the indicia to travel along respective folded optical paths within the housing to the respective imagers.
